(19) United States
(12) Patent Application Publication
(10) Pub. No.: US 2007/0299576 A1
(43) Pub. Date: Dec. 27, 2007

(54) Method for operating control devices of a motor vehicle which communicate via a databus

(75) Inventors: Karl-Peter Spring, Neuffen (DE); Christoph Mross, Stuttgart (DE); Ruediger Roppel, Flieden (DE)

Correspondence Address: LERNER GREENBERG STEMER LLP, P O BOX 2480, HOLLYWOOD, FL, 33022-2480, US

(73) Assignee: Dr. Ing. h.c. F. Porsche Aktiengesellschaft

(21) Appl. No.: 11/821,687

(22) Filed: Jun. 25, 2007

(30) Foreign Application Priority Data
Jun. 24, 2006 (DE) 10 2006 029 171.9

(51) Int. Cl. G01M 17/00

(52) U.S. Cl. 701/29

(57) ABSTRACT

A method operates control devices of a motor vehicle which communicate via at least one databus. A gateway control device which controls the transmission of data on the databus, or on each databus, and a plurality of motor vehicle control devices which control the functions of an assembly such as, for example, of an engine, of a gearbox or of an air conditioning system of the motor vehicle, are connected to the databus, or to each databus. One of the control devices, preferably the gateway control device, generates centrally a diagnostic message which is valid for the other control devices, preferably for the motor vehicle control devices, and transmits the diagnostic message to the other control devices on the databus, or on each databus. The other control devices then exclusively perform fault storage if a fault storage function is activated by the diagnostic message.

### CROSS-REFERENCE TO RELATED APPLICATION

This application claims the priority, under 35 U.S.C. §119, of German application DE 10 2006 029 171.9, filed Jun. 24, 2006; the prior application is herewith incorporated by reference in its entirety.

### BACKGROUND OF THE INVENTION

### Field of the Invention

The invention relates to a method for operating control devices of a motor vehicle which communicate via at least one databus. A gateway control device which controls the transmission of data on the databus, or on each databus, and a plurality of motor vehicle control devices which control the function of assemblies such as, for example, of an engine, of a gearbox or of an air conditioning system of the motor vehicle, are connected to the databus.

Motor vehicles have a large number of control devices which communicate, or exchange data with one another, via at least one databus. The control devices include motor vehicle control devices which can be used to control the function of assemblies of the motor vehicle such as, for example, the function of an engine, of a gearbox or of an air conditioning system. Furthermore, these control devices include what is referred to as a gateway control device which controls the transmission of data on the databus, or on each databus. In motor vehicles which are known from practice, each control device of a motor vehicle checks the communication with or transmission of data to, other control devices. If it is detected in this context that a data transmission fault has occurred, it is already known from practice to store a fault indication, corresponding to the detected data transmission fault, in the control device which has detected the fault.

In order to avoid fault indications being stored owing to operating conditions which are invalid for the detection of a fault even though no fault at all has occurred in the transmission of data, it is already known from practice that each control device which is connected to the databus, or to each databus, checks separately whether operating conditions which are valid for the detection of a fault are present. However, since this checking can lead to diverging results in the different control devices, there is still a relatively high probability of fault messages being stored even if there are no faults in the transmission of data between the control devices. This makes fault diagnostics more difficult when the stored fault indications are read out later.

### SUMMARY OF THE INVENTION

It is accordingly an object of the invention to provide a method for operating control devices of a motor vehicle which communicate via a databus which overcomes the above-mentioned disadvantages of the prior art methods of this general type.

According to the inventive method, one of the control devices, preferably the gateway control device, generates centrally a diagnostic message which is valid for the other control devices, preferably for the motor vehicle control devices, and transmits the diagnostic message to the other control devices on the databus, or on each databus, wherein the other control devices perform fault storage only if a fault storage function is activated by the diagnostic message.

Within the meaning of the present invention it is proposed that a control device generates and transmits centrally a diagnostic message which is valid for all the other control devices, wherein the control devices can store possibly detected faults only if a fault storage function of the control devices is activated on the basis of the diagnostic message. In this way it is possible to ensure that it is checked centrally for all the control devices which are connected to the databus, or to each databus, whether operating conditions which are valid for satisfactory detection of faults are present. The probability of fault messages being stored even though no fault has occurred in the transmission of data, can thus be reduced to a minimum.

The motor vehicle control devices preferably continuously check the transmission of data to other control devices which are connected to the databus, or to each databus, and only if the fault storage function of the motor vehicle control devices is activated by the diagnostic message, is a fault indication which corresponds to the possibly detected data transmission fault stored in the respective motor vehicle control device which has detected the data transmission fault.

According to one advantageous development of the invention, the gateway control device checks centrally whether valid operating conditions are present for the fault storage function of the motor vehicle control devices, wherein the diagnostic message is generated as a function thereof.

Other features which are considered as characteristic for the invention are set forth in the appended claims.

Although the invention is described herein as embodied in a method for operating control devices of a motor vehicle which communicate via a databus, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific.

### DETAILED DESCRIPTION OF THE INVENTION

The invention relates to a method for operating control devices of a motor vehicle which preferably communicate with one another via at least one databus and thus exchange data with one another via the databus, or via each databus. In this context, a gateway control device which controls the transmission of data on the databus, or on each databus, is connected to the databus, or to each databus. Furthermore, a plurality of motor vehicle control devices which control the function of assemblies of the motor vehicle, thus for example a control device for controlling an engine of the motor vehicle, a control device for controlling a gearbox of the motor vehicle and a control device for controlling an air conditioning system of the motor vehicle, are connected to the databus, or to each databus. The gateway control device continuously checks the transmission of data to each motor vehicle control device. Likewise, each motor vehicle control device checks the transmission of data to control devices with which the respective motor vehicle control device exchanges data.

According to the invention, it is proposed, for the operation of the control devices, that at least one of the control devices, preferably the gateway control device, checks centrally whether operating conditions which are valid for detection of faults in the transmission of data are present. As a function of this, the gateway control device generates a diagnostic message which is valid for all the motor vehicle control devices and transmits the diagnostic message to the corresponding motor vehicle control devices on the databus, or on each databus, wherein the motor vehicle control devices perform fault storage of a possibly detected data transmission fault only if a fault storage function of the motor vehicle control devices is activated by the diagnostic message which is generated by the gateway control device.

Accordingly, it lies within the meaning of the present invention that the motor vehicle control devices, like the gateway control device, continuously check the transmission of data to other control devices which are connected to the databus, or to each databus, that, however, the motor vehicle control devices store a possibly detected fault only if the fault storage function of the motor vehicle control devices is activated by the diagnostic message which is generated by the gateway control device. In this case, a fault message which corresponds to the possibly detected data transmission fault is stored in the motor vehicle control device which has detected the data transmission fault.

A diagnostic bit is preferably generated as a diagnostic message, wherein, if the diagnostic bit assumes a first logic value, in particular a logic “1”, the fault storage function of the motor vehicle control devices is activated, and wherein, if the diagnostic bit assumes a second logic value, in particular a logic “0”, the fault storage function of the motor vehicle control devices is deactivated.

It lies within the meaning of the present invention here that the diagnostic bit assumes the second logic value for deactivating the fault storage function in particular if an operating condition which is invalid for the detection of faults is present on the databus, or on each databus. This is the case in particular if an engine of the motor vehicle is started or an ignition device of the motor vehicle is switched off or a data network which is formed by the databus, or by each databus, is powered up, or there is an undervoltage on at least one databus.

It lies accordingly within the meaning of the present invention that motor vehicle control devices continuously check the transmission of data on the databus, or on each databus, but that the motor vehicle control devices can store a detected fault only if a fault storage function of the motor vehicle control devices is activated by a diagnostic message which is generated by the gateway control device. Accordingly, whether fault storage is permitted or not is predefined centrally for all the motor vehicle control devices by the gateway control device.

The gateway control device can monitor the transmission of data to the motor vehicle control devices which are connected to the databus, or to each databus, both when the ignition device is switched on and when the ignition device of the motor vehicle is switched off, and if a fault is detected in the data transmission, the gateway control device can store a fault message, corresponding to the detected data transmission fault, in the gateway control device. The motor vehicle control devices can, however, only store detected data transmission faults if this is permitted by the diagnostic message which is generated by the gateway control device. It is to be noted that the data transmission by the gateway control device is monitored directly each time after the data network which contains the databus, or each databus, is powered up.

1. A method of operating control devices of a motor vehicle which communicate through at least one databus, the control devices including a gateway control device for controlling a transmission of data on the at least one databus and a plurality of motor vehicle control devices controlling a functioning of assemblies of the motor vehicle, which comprises the steps of:
generating centrally, via one of the control devices, a diagnostic message being valid for all others of the control devices;
transmitting the diagnostic message to the other control devices on the at least one databus; and
performing fault storage in the other control devices only if a fault storage function is activated by the diagnostic message.

2. The method according to claim 1, which further comprises checking centrally, via the gateway control device, whether valid operating conditions are present for the fault storage function of the other control devices, and the diagnostic message is generated in dependence on the valid operation conditions.

3. The method according to claim 1, which further comprises deactivating the fault storage function of the motor vehicle control devices by means of the diagnostic message if one of an engine of the motor vehicle is started, an ignition device of the motor vehicle is switched off, a data network containing the at least one databus is powered up, and there is an under-voltage on the at least one databus.

4. The method according to claim 1, which further comprises generating a diagnostic bit as the diagnostic message, and if the diagnostic bit assumes a first logic value, the fault storage function of the motor vehicle control devices is activated, and if the diagnostic bit assumes a second logic value, the fault storage function of the motor vehicle control devices is deactivated.

5. The method according to claim 1, which further comprises:
continuously checking, via the motor vehicle control devices, for the transmission of data to the other control devices which are connected to the at least one databus; and
storing a fault message corresponding to a possibly detected data transmission fault in the respective motor vehicle control device which has detected a fault only if the fault storage function of the motor vehicle control devices is activated by means of the diagnostic message.

6. The method according to claim 1, which further comprises:
monitoring the transmission of data to the motor vehicle control devices connected to the databus, by the gateway control device, both when an ignition device is switched on and when the ignition device of the motor vehicle is switched off; and
storing a fault message corresponding to a detected data transmission fault, in the gateway control device, if a data transmission fault is detected in this context.

7. The method according to claim 6, which further comprising carrying out the monitoring of the transmission of data to the motor vehicle control devices by the gateway control device directly each time after a data network which includes the at least one databus, is powered up.

8. The method according to claim 1, which further comprises generating the diagnostic message via the gateway control device.

9. The method according to claim 8, wherein the diagnostic message is valid for the motor vehicle control devices.

10. The method according to claim 1, which further comprises selecting the assemblies from the group consisting of an engine, a gearbox and an air conditioning system of the motor vehicle.

11. The method according to claim 1, wherein the control devices are connected to a plurality of databuses.
